(19) United States
(12) Patent Application Publication
(10) Pub. No.: US 2015/0271170 A1
(43) Pub. Date: Sep. 24, 2015

(54) INFORMATION PROCESSING APPARATUS, INFORMATION PROCESSING SYSTEM, INFORMATION PROCESSING METHOD, AND RECORDING MEDIUM

(71) Applicant: Sharp Kabushiki Kaisha, Osaka (JP)

(72) Inventor: Junji NITTA, Osaka-shi (JP)

(21) Appl. No.: 14/656,773

(22) Filed: Mar. 13, 2015

(30) Foreign Application Priority Data
Mar. 20, 2014 (JP) 2014-058822

(51) Int. Cl. H04L 29/06; G06F 12/14

(52) U.S. Cl. CPC H04L 63/0815; G06F 12/1458; H04L 63/083

(57) ABSTRACT

A server apparatus (information processing apparatus) receives an access request through a communication network. The server apparatus determines whether a request source of a received access request is an authenticated person representing an authenticated request source, and if it is determined that the request source is the authenticated person, secures a storage location of data in response to a request of the authenticated person. Further, the server apparatus executes storage processing of data in a secured storage location. The server apparatus includes a storage unit which stores location information representing a storage location and an access request permitting access to the storage location in association with each other. If it is determined that the request source is the access request stored in the storage unit when receiving the access request, the server apparatus permits access to the corresponding storage location.

### CROSS-REFERENCE TO RELATED APPLICATIONS

This Nonprovisional application claims priority under 35 U.S.C. §119(a) on Patent Application No. 2014-058822 filed in Japan on Mar. 20, 2014, the entire contents of which are hereby incorporated by reference.

### FIELD

The present invention relates to an information processing apparatus, an information processing system, an information processing method, and a recording medium performing information processing based on an access request received through a communication network.

### BACKGROUND

Recently, an information processing system which enables each of a plurality of users to access a common storage location in which data are stored such that users may perform file sharing by receiving and transmitting data (a shared file) through the storage location has been widespread. In the information processing system, a server apparatus is connected to a communication network such as the Internet, and a plurality of users access the server apparatus having a storage location of the shared file through a web browser or the like. In the above-described information processing system, the server apparatus is connected to the communication network, and therefore there is a need to prevent information from being leaked from the server apparatus due to an illegal access or the like. For example, a user who may access the server apparatus is registered in advance, and if sharing a file, the user is authenticated by using information such as a login ID, a login password or the like. In an information processing system described in Japanese Patent Laid-Open No. 2008-262293, information on a plurality of users which may access the server apparatus is stored in a user information table, and a user is authenticated by determining whether the user accessing a shared file has an access authority to the shared file.

### SUMMARY

Since the information processing system sharing the file as described above provides a service to the registered user, for a registered person and a non-registered person to share a file, the non-registered person needs to be registered, and therefore there is a problem in convenience.

In consideration of the above-described circumstances, it is an object of the present invention to provide an information processing apparatus an information processing system, an information processing method, and a recording medium capable of improving convenience if sharing a file and maintaining security.

An information processing apparatus according to the present invention is characterized by comprising: a receiving unit configured to receive an access request through a communication network; an authenticated person determination unit configured to determine whether a request source of the access request received by the receiving unit is an authenticated person representing an authenticated request source; a storage location securing unit configured, if the authenticated person determination unit determines that the request source is the authenticated person, to secure a storage location of data in response to a request of the authenticated person; an execution unit configured to execute storage processing of data in the storage location secured by the storage location securing unit; a storage unit configured, after the storage location securing unit secures the storage location of data, to store location information representing the storage location and an access request to be permitted access to the storage location in association with each other; a storage determination unit configured, if the receiving unit receives an access request, to determine whether the access request is stored in the storage unit; and an access permission unit configured to permit access to the storage location represented by the location information corresponding to the access request if the storage determination unit determines that the access request is stored in the storage unit.

The information processing apparatus according to the present invention is characterized in that the storage unit is configured to store password information in association with the access request, the information processing apparatus further comprises: a password information receiving unit configured, if the storage determination unit determines that an access request is stored in the storage unit, to receive password information; and a password information determination unit configured to determine whether password information received by the password information receiving unit agrees with the password information stored in the storage unit in association with the access request, and wherein, the access permission unit is configured to permit access to the storage location represented by the location information corresponding to the access request if the password information determination unit determines that the received password information agrees with the stored password information.

The information processing apparatus according to the present invention is characterized in that the access request includes a URL requesting access, the storage unit is configured to store contact information representing a contact address of a permitted person to be permitted access to the storage location, in association with the location information representing the storage location and the access request corresponding to the location information, and the information processing apparatus further comprises: a URL notification unit configured to notify, of the URL included in the access request corresponding to the contact information stored in the storage unit, the contact address represented by the contact information.

The information processing apparatus according to the present invention is characterized by further comprising a generation unit configured, based on the contact information, to generate the URL included in the access request corresponding to the contact information.

The information processing apparatus according to the present invention is characterized in that the storage unit is configured to store a time point when the generation unit generates the URL and an update timing of the URL, in association with the access request including the URL, the information processing apparatus further comprises: an update determination unit configured to determine, based on the time point when the URL is generated and the update timing of the URL, whether an update of the URL is required, and wherein, if the update determination unit determines that the update of the URL is required, the generation unit is configured to generate a URL different from the URL required to be updated.

The information processing apparatus according to the present invention is characterized by further comprising a storage processing notification unit configured, if storage processing is executed for the storage location represented by the location information stored in the storage unit, based on the request of the request source which is determined to be the authenticated person, to give a notification to the contact address represented by the contact information corresponding to the location information.

The information processing apparatus according to the present invention is characterized in that the execution unit is configured, in response to a request of the request source of the access request for which access to the storage location is permitted by the access permission unit, to execute storage processing for the storage location, the storage unit is configured to store authenticated person contact information representing the contact address of the authenticated person securing the storage location, in association with the location information representing the storage location, and if the execution unit executes the storage processing for the storage location in response to the request of the request source, the storage processing notification unit is configured to give a notification to the contact address represented by the authenticated person contact information corresponding to the location information representing the storage location.

An information processing system according to the present invention is characterized by comprising: the information processing apparatus described above; a data storage apparatus having a storage location of data on which the information processing apparatus executes storage processing; and an authentication apparatus configured to authenticate whether a request source of an access request received by the information processing apparatus is an authenticated person to be allowed to secure the storage location of data in the information processing apparatus, and output an authentication result to the information processing apparatus, wherein the information processing apparatus is configured to determine whether the request source is the authenticated person based on an authentication result output from the authentication apparatus.

An information processing method according to the present invention is characterized by comprising the steps of receiving an access request through a communication network; determining whether a request source of the received access request is an authenticated person representing an authenticated request source; if it is determined that the request source is the authenticated person, securing a storage location of data in response to a request of the authenticated person; executing storage processing of data in the secured storage location; after the storage location of data is secured, storing location information representing the storage location and an access request to be permitted access to the storage location in association with each other; if an access request is received, determining whether the access request is stored, and permitting access to the storage location represented by the location information corresponding to the access request if the access request is determined as being stored.

A computer program according to the present invention is characterized by causing a computer, connected to a communication network to receive an access request through the communication network, to execute the steps of: determining whether a request source of the received access request is an authenticated person representing an authenticated request source; if it is determined that the request source is the authenticated person, securing a storage location of data in response to a request of the authenticated person; executing storage processing of data in the secured storage location; after the storage location of data is secured, storing location information representing the storage location and an access request to be permitted access to the storage location in association with each other; if an access request is received, determining whether the access request is stored, and permitting access to the storage location represented by the location information corresponding to the access request if the access request is determined as being stored.

According to the present invention, if sharing a file, convenience therefor may be improved while maintaining the security.

The above and further objects and features will more fully be apparent from the following detailed description with accompanying drawings.

### BRIEF DESCRIPTION OF THE DRAWINGS

FIG. 1 is a schematic view illustrating the whole of a file sharing system according to Embodiment 1.

FIG. 2 is a block diagram illustrating a configuration of each apparatus of the file sharing system.

FIG. 3 is an explanation view illustrating a detailed example of a registered information table.

FIG. 4 is an explanation view illustrating a detailed example of an access permission table.

FIG. 5 is an explanation view illustrating a detailed example of an update management table.

FIG. 6 is a flow chart illustrating a processing procedure of a server apparatus if receiving an access request.

FIG. 7 is a flow chart illustrating a subroutine of login user processing.

FIG. 8 is a flow chart illustrating a subroutine of external user processing.

FIG. 9 is a flow chart illustrating a processing procedure of a server apparatus if updating a URL for permitting access to a specific folder.

FIG. 10 is a block diagram illustrating a configuration of each apparatus of a file sharing system according to Embodiment 2.

FIG. 11 is a flow chart illustrating a processing procedure of a server apparatus if receiving the access request.

FIG. 12 is a flow chart illustrating a processing procedure of an authentication apparatus if receiving the access request.

### DETAILED DESCRIPTION OF NON-LIMITING EXAMPLE EMBODIMENTS

Hereinafter, embodiments of the present invention will be described with reference to the accompanying drawings.

### Embodiment 1

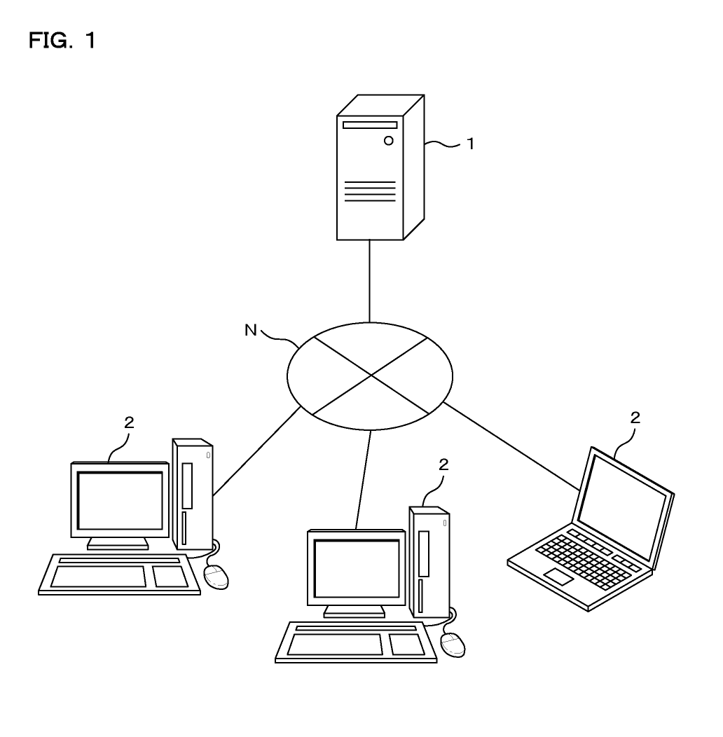

FIG. 1 is a schematic view illustrating the whole of a file sharing system according to Embodiment 1. The file sharing system includes a server apparatus 1 and a plurality of client apparatuses 2, in which each apparatus is connected to a network N. The client apparatus 2 receives an operation from a user and transmits an access request for requesting access to the server apparatus 1 to the server apparatus 1. The server apparatus 1 receives an access request from the client apparatus 2 and determines whether to permit access from the client apparatus 2 based on the received access request. When authenticating a request source of the access request, the server apparatus 1 permits access from the request source, and secures a storage location in which data are stored, stores the data in the secured storage location, or reads out the data from the storage location, or the like, based on the request of the request source. Further, if receiving the access request for requesting a specific uniform resource locator (URL), the server apparatus 1 permits access to the storage location corresponding to the URL, and performs processing relating to the storage of the data in the storage location, the reading of the data from the storage location, or the like. In Embodiment 1, the storage location is represented by a folder. That is, the securing of the storage location by the server apparatus 1 corresponds to generation of the folder, and the storage of the data in the storage location corresponds to the storage of the data in the folder. Herein, a user who is the request source of the access request to be authenticated by the server apparatus 1 is referred to as a login user and a user who is the request source of the access request requesting the specific URL is referred to as an external user. The network N includes a public communication network such as the Internet. Further, in Embodiment 1, the server apparatus 1 corresponds to an information processing apparatus, a data storage apparatus, and an authentication apparatus of the present invention.

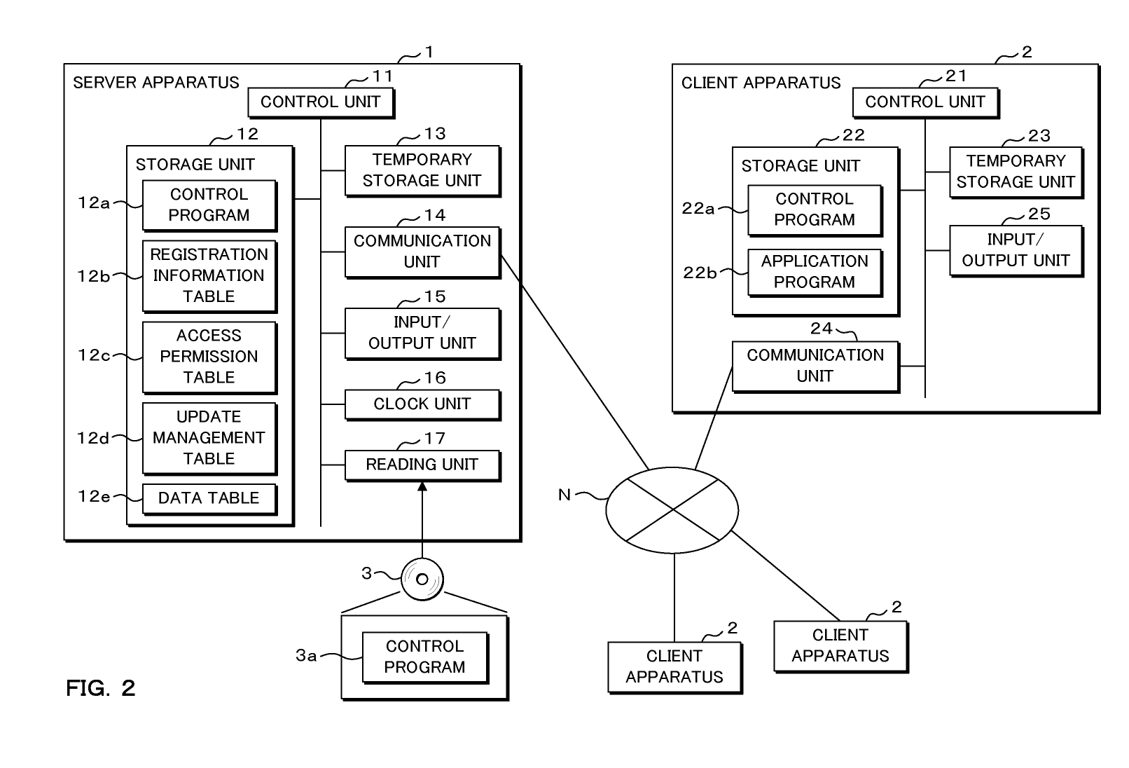

FIG. 2 is a block diagram illustrating a configuration of each apparatus of the file sharing system. The client apparatus 2 includes a control unit 21 which controls an operation of each component of the client apparatus 2. The control unit 21 includes, for example, one or a plurality of central processing units (CPUs), a multi-core CPU or the like. In addition, the client apparatus 2 includes a storage unit 22, a temporary storage unit 23, a communication unit 24, and an input/output unit 25, which are connected to the control unit 21 through a bus. The control unit 21 controls each unit by reading a control program 22a which is stored in the storage unit 22 to be described below.

The storage unit 22 is configured with a nonvolatile memory such as an electrically erasable and programmable ROM (EEPROM), a flash memory, and a hard disk drive (HDD) or the like. In the storage unit 22, the control program 22a is stored. The control program 22a is a program in which processing contents executed by the control unit 21 to control each unit included in the client apparatus 2 are described. Further, in the storage unit 22, an application program 22b is stored. The application program 22b is a program executing applications such as a web browser for communicating with the server apparatus 1, for example. The control unit 21 controls the communication unit 24 to be described below by executing the application program 22b, the communication unit 24 performing connection processing to the network N or the like.

The temporary storage unit 23 is configured a memory such as a static RAM (SRAM), a dynamic RAM (DRAM) or the like. The temporary storage unit 23 temporarily stores various kinds of data which are generated by allowing the control unit 21 to perform processing by the control program 22a or the application program 22b.

The communication unit 24 is configured to be connectable to the network N, and transmits and receives information to and from the server apparatus 1 by communication protocols such as a hypertext transfer protocol (HTTP) a file transfer protocol (FTP), or the like, based on commands from the control unit 21. Further, the communication unit 24 may perform the communication with the server apparatus 1 under the encrypted condition by using protocols such as secure shell (SSH), secure socket layer/transport layer security (SSL/TLS) or the like.

The input/output unit 25 is connected to an input/output apparatus such as a keyboard, a display, etc. from an outside, outputs an input signal from the input/output apparatus to the control unit 21, and outputs an output signal from the control unit 21 to the input/output apparatus.

The client apparatus 2 configured as described above receives an operation from the user through the input/output unit 25, and the control unit 21 controls each unit in response to the operation of the user. The client apparatus 2 executes the application program 22b based on the operation of the user to become the login user or the external user, and transmits a request such as the access request to the server apparatus 1 through the communication unit 24. The client apparatus 2 displays a response to the access request from the server apparatus 1 on a display, or the like to notify the user of a communication result with the server apparatus 1.

The server apparatus 1 includes a control unit 11 which controls an operation of each component of the server apparatus 1. The control unit 11 includes, for example, one or a plurality of CPUs, a multi-core CPU or the like. Further, the server apparatus 1 includes a storage unit 12, a temporary storage unit 13, a communication unit 14, and an input/output unit 15, a clock unit 16, a reading unit 17, which are connected to the control unit 11 through a bus. The control unit 11 controls each unit by reading a control program 12a stored in the storage unit 12 to be described below.

The storage unit 12 is configured with a nonvolatile memory such as an EEPROM, a flash memory, an HDD or the like. In the storage unit 12, the control program 12a is stored. The control program 12a is a program in which processing contents performed by communication with the client apparatus 2 and processing contents executed by the control unit 11 to control each unit included in the server apparatus 1 are described.

Further, in the storage unit 12, a registration information table 12b, an access permission table 12c, an update management table 12d, and a data table 12e are stored. In the registration information table 12b, information relating to the login user is stored. In the access permission table 12c, information relating to the URL which may access a specific folder is stored. In the update management table 12d, information relating to the update of the URL which may access the specific folder is stored. In the data table 12e, data stored in the folder is stored. In the data table 12e, data is stored so as to identify the folder of the storage location and a stored user. Further, the registration information table 12b, the access permission table 12c, and the update management table 12d will be described below.

The temporary storage unit 13 is configured with a memory such as the SRAM, the DRAM or the like. The temporary storage unit 13 temporarily stores various kinds of data which are generated by allowing the control unit 11 to perform the processing by the control program 12a.

The communication unit 14 is configured to be connected to the network N, and transmits and receives information to and from the client apparatus 2 by the communication protocols such as the HTTP, the FTP, or the like, based on the commands from the control unit 11. Further, the communication unit 14 may perform the communication with the client apparatus 2 under the encrypted condition by using the protocols such as the SSH, the SSL/TLS or the like.

The input/output unit 15 is connected to the an input/output apparatus such as the keyboard, the display, etc. from the outside, outputs an input signal from the input/output apparatus to the control unit 11, and outputs an output signal from the control unit 11 to the input/output apparatus.

The clock unit 16 includes a real time clock, a timer and the like. The clock unit 16 outputs an elapsed time starting with a current time or any point of time to the control unit 11.

The reading unit 17 reads data which are recorded in a recording medium 3 such as a USB device, a CD-ROM, a DVD, a Blu-ray disk, a flexible disk, or the like, and stores the read data in the temporary storage unit 13 or the storage unit 12. The recording medium 3 is stored with the control program 3a which is executed by the control unit 11 to operate the server apparatus 1. The control program 12a stored in the storage unit 12 may be a copy of the control program 3a which is read from the recording medium 3 by the reading unit 17.

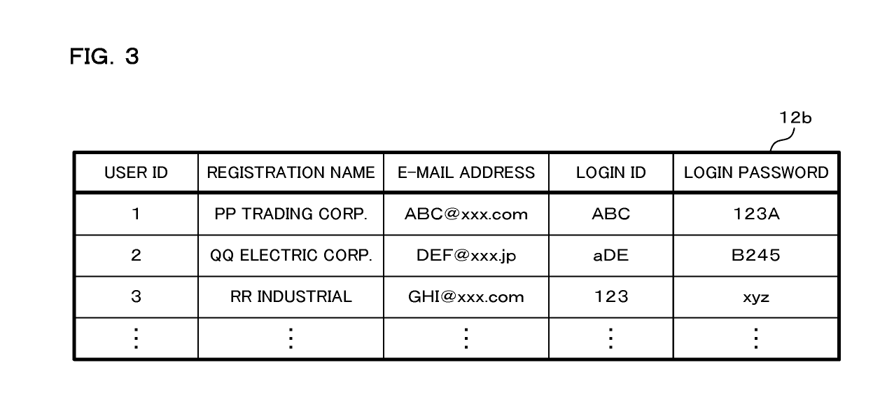

FIG. 3 is an explanation view illustrating a detailed example of the registration information table 12b. The registration information table 12b is stored with a registration name, an e-mail address, a login ID, and a login password for each user ID. The user ID is an ID for identifying the login user. The registration name represents a name of a user to become the login user, and is represented by any character string regardless of a corporate name and a personal name. The e-mail address is a contact address of the corresponding login user, and corresponds to contact information of an authenticated person of the present invention. The login ID and the login password are information for authenticating the login user, and if the access request is received from the client apparatus 2, are used for authenticating the request source of the access request.

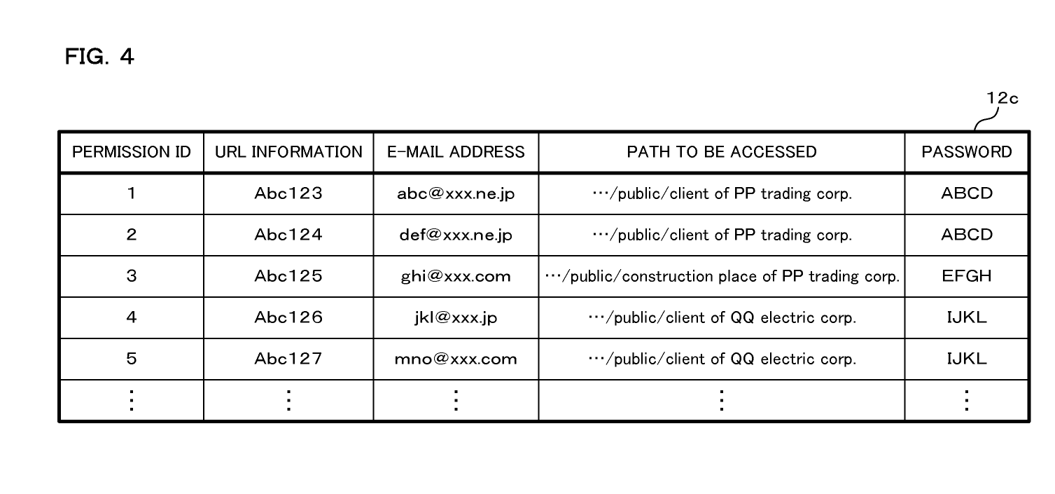

FIG. 4 is an explanation view illustrating a detailed example of the access permission table 12c. In the access permission table 12c, URL information, an e-mail address, a path to be accessed, and a password are stored for each permission ID. The permission ID is an ID for identifying the URL which may access a specific folder of the server apparatus 1. The URL information is information including at least a part of the URL and is, for example, a value of query string of the URL. The e-mail address is a contact address of a user to be notified of the URL which may access the specific folder, and corresponds to the contact information of the present invention. The path to be accessed is a path representing a location of the accessible folder, and corresponds to the location information of the present invention. The password is a password requested if accessing the folder, and corresponds to password information of the present invention. Herein, the storage unit 12 is stored with a residual part other than the URL information from the URL which may access the specific folder, in association with the URL information. For example, if the URL information is the query character string value of the URL, the residual part includes a scheme, a host name, a path, and a name of query string, and the like, of the URL. Therefore, the URL which may access the specific folder is stored in the storage unit 12, in association with the e-mail address, the path to be accessed, and the password.

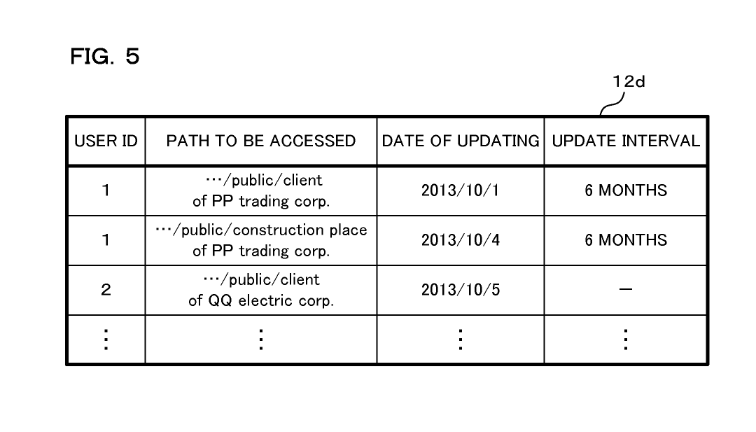

FIG. 5 is an explanation view illustrating a detailed example of the update management table 12d. In the update management table 12d, a path to be accessed, a date of updating, and an update interval is stored for each user ID described above. The date of updating represents a latest date when the URL information stored in the access permission table 12c is generated, and the update interval represents an interval from a date when the URL information is formerly generated to a date when the next URL information is generated.

Further, the generation of the URL information will be described below. Hereinafter, rows of the registration information table 12b, the access permission table 12c, and the update management table 12d are referred to as a record.

The server apparatus 1 configured as described above receives the request such as the access request transmitted from the above-described client apparatus 2, and executes various kinds of processing based on the received request. Hereinafter, the processing when the server apparatus 1 receives the access request, and the processing when the processing when the URL which may access the specific folder is updated will be described using a flow chart.

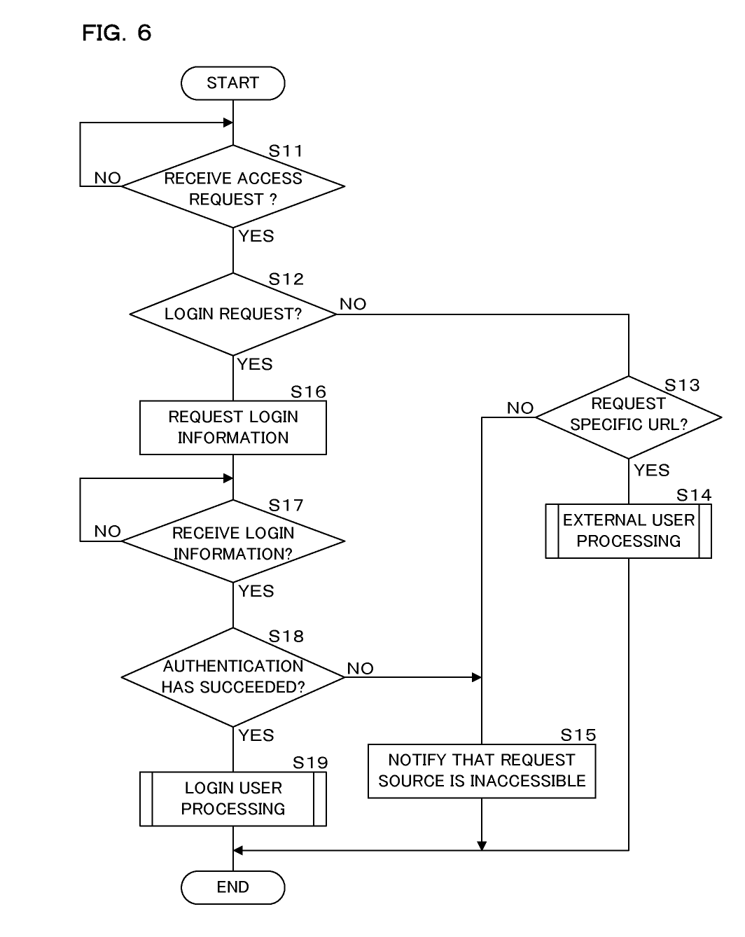

FIG. 6 is a flow chart illustrating a processing procedure of the server apparatus 1 if receiving the access request. The control unit 11 of the server apparatus 1 determines whether the communication unit 14 receives the access request from the client apparatus 2 (step S11). If it is determined that the communication unit 14 does not receive the access request (NO in S11), the control unit 11 waits for the processing until the communication unit 14 receives the access request from the client apparatus 2. Further, the communication unit 14 corresponds to a receiving unit of the present invention.

If it is determined that the communication unit 14 receives the access request (YES in S11), the control unit 11 determines whether the access request from the client apparatus 2 is the login request (step S12). For example, in order to authenticate whether the request source of the access request is the login user, the server apparatus 1 is configured to store the web page for urging the input of the login ID and the login password in the storage unit 12. In this case, the control unit 11 performs the determination based on whether the URL included in the received access request represents the storage location of the web page.

If it is determined that the access request is not the login request (NO in S12), the control unit 11 determines whether the received access request requests a specific URL (step S13). In detail, the control unit 11 performs the determination based on whether the URL included in the received access request is present in a plurality of URLs including the URL information stored in the access permission table 12c and the residual part of the URL stored in the storage unit 12 in association with the URL information. Further, the control unit 11 executes the control program 12a in step S13, and thus serves as a storage determination unit of the present invention.

If it is determined that the specific URL is requested (YES in S13), the control unit 11 performs external user processing (step S14), and then ends the processing. The external user processing is processing which is, if the request source of the access request to the server apparatus 1 is the external user, executed by the control unit 11 in response to the request of the external user, and details thereof will be described below. Meanwhile, if it determined that the specific URL is not requested (NO in S13), the control unit 11 notifies the request source of the access request that the request source is inaccessible (step S15), and then ends the processing. In step S15, the control unit 11 transmits, for example, a message representing the fact that accessing the server apparatus 1 cannot be performed to the client apparatus 2 which transmits the access request.

In step S12, if it is determined that the received access request is the login request (YES in S12), the control unit 11 requests the login information including the login ID and the login password to the request source of the access request (step S16). The control unit 11 transmits the information for displaying the above-described web page for urging the input of the login ID and the login password to the client apparatus 2 which transmits the access request.

Then, the control unit 11 determines whether the communication unit 14 receives the login information (step S17). If it is determined that the communication unit 14 does not receive the login information (NO in S17), the control unit 11 waits for the processing until the communication unit 14 receives the login information.

If it is determined that the communication unit 14 receives the login information (YES in S17), the control unit 11 determines whether the authentication of the request source of the access request has succeeded by using received login information (step S18). In detail, the control unit 11 performs the determination based on whether a record agreeing with a set of the login ID and the login password which are included in the received login information is stored in the registration information table 12b. Further, the control unit 11 executes the control program 12a in step S18, and thus serves as an authenticated person determination unit of the present invention.

If it is determined that the authentication has not succeeded (NO in S18), the control unit 11 proceeds to step S15. Meanwhile, if it is determined that the authentication has succeeded (YES in S18), the control unit 11 performs the login user processing (step S19), and then ends the processing. The login user processing is processing executed by the control unit 11 in response to the request of the login user if the request source of the access request to the server apparatus 1 is the login user, and the details thereof will be described below.

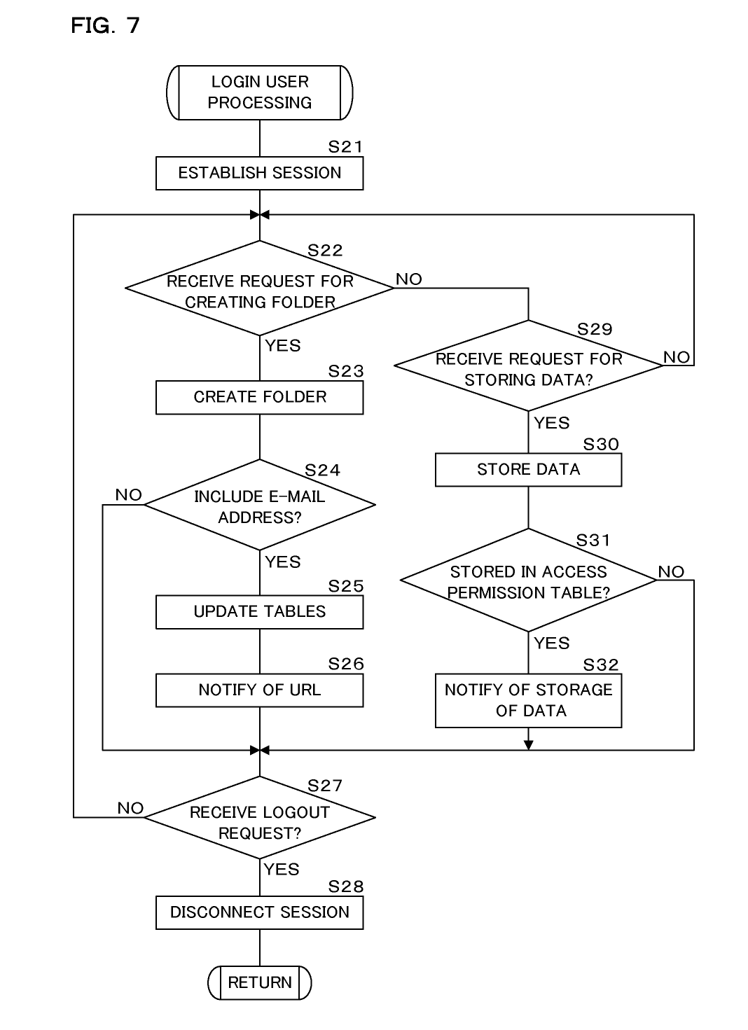

FIG. 7 is a flow chart illustrating a subroutine of the login user processing. The control unit 11 of the server apparatus 1 establishes a session with the client apparatus 2 which is a transmission source of the access request if it is determined that the authentication succeeds in step S18 of FIG. 6 (step S21). Herein, the user who operates the client apparatus 2 is the login user, and corresponds to the authenticated person of the present invention. Further, in FIG. 7, the request received by the server apparatus 1 after step S21 is a request from the client apparatus 2 in which the session is established.

Then, the control unit 11 determines whether the communication unit 14 receives a request for creating a folder (step S22). The request for creating a folder includes, for example, a name of the folder and a location for creating the folder. Further, the request for creating a folder may include the e-mail address of the user to become one or a plurality of external users, the password required if the user accesses the folder as the external user, and the update interval of the URL required if the user accesses the folder as the external user. If it is determined that the communication unit 14 receives the request for creating a folder (YES in S22), the control unit 11 creates a folder based on the received request for creating a folder (step S23). Further, the control unit 11 executes the control program 12a in step S23, and thus serves as a storage location securing unit of the present invention.

Then, the control unit 11 determines whether the received request for creating a folder includes the e-mail address of the user who may become the external user (step S24). If it is determined that the received request for creating a folder does not include the e-mail address of the user who may become the external user (NO in S24), the control unit 11 proceeds to the step S27. If it is determined that the received request for creating a folder includes the e-mail address of the user who may become the external user (YES in S24), the control unit 11 updates the tables (step S25). In detail, the control unit 11 individually generates the URL information based on each e-mail address included in the request for creating a folder. Next, the control unit 11 stores, as one record, the generated URL information and the e-mail address, a path to be accessed, and a password which are included in the request for creating a folder in the access permission table 12c. Further, the control unit 11 stores, as one record, a user ID of the login user, a path to be accessed, a date when the URL information is generated, and an update interval in the update management table 12d. Hereinafter, a detailed example of the update of the tables which are executed by the control unit 11 in step S25 is described.

An example in which the communication unit 14 receives the access request of the folder from a login user identified user ID having a value of 2 (two), that is, a login user having a registration name of “xx electricity” (see FIG. 3) will be described. It is assumed that the request for creating a folder includes information that a folder name is “client of QQ electric corp.,” a generation location is “ . . . public/client of QQ Electric Corp.,” an e-mail address is “jkl@xxx.jp” and “mno@xxx.com,” and a password is “IJKL.” The control unit 11 stores contents corresponding to records of which the permission IDs within the access permission table 12c of FIG. 4 have values of 4 and 5 respectively in the access permission table 12c. In this case, the control unit 11 generates the URL information based on the e-mail address. A generation method uses, for example, an algorithm which generates a random character string using a character string of a local part of the e-mail address. Further, the control unit 11 stores a content corresponding to a record of which the user ID of the update management table 12d of FIG. 5 has a value of 2 (two) in the update management table 12d. Further, if generating the URL information in step S25, the control unit 11 executes the control program 12a, and thus serves as a generation unit of the present invention.

The control unit 11 performs the above processing in step S25 and then notifies the user to become the external user of the URL including the generated URL information (step S26). In detail, the control unit 11 refers to the access permission table 12c, and transmits a message to each e-mail address included in the request for creating a folder through communication unit 14. The message includes the URL included in the URL information corresponding to the each e-mail address. Further, the control unit 11 executes the control program 12a in step S26, and thus serves as a URL notification unit of the present invention.

Then, the control unit 11 determines whether the communication unit 14 receives a logout request (step S27). The logout request is a request for disconnecting the session which is established in step S21. If it is determined that the logout request is not received (NO in S27), the control unit 11 returns the processing to step S22. If it is determined that the logout request is received (YES in S27), the control unit 11 disconnects the session established in step S21 (step S28), returns a subroutine of the login user processing to the processing of FIG. 6, and then ends the processing.

Meanwhile, if it is determined that communication unit 14 does not receive the request for creating a folder in step S22 (NO in S22), the control unit 11 determines whether the communication unit 14 receives a request for storing data from the login user (step S29). The storage request of the data includes, for example, a path to the folder representing the storage location of data and data to be stored. If it is determined that the communication unit 14 does not receive the request for storing data (NO in S29), the control unit 11 returns the processing to step S22.

If it is determined that the communication unit 14 receives the request for storing data (YES in S29), the control unit 11 stores data based on the received request (step S30). The control unit 11 stores, for example, as one record, a set including a path to a folder representing a location for storing data included in the request for storing data, an user ID identifying the login user, and data to be stored included in the request for storing data in the data table 12e. Further, the control unit 11 executes the control program 12a in step S30, and thus serves as an execution unit of the present invention.

Then, the control unit 11 determines whether the path to the folder storing the data in step S30 is stored in the access permission table 12c (step S31). If it is determined that the path to the folder is not stored in the access permission table 12c (NO in S31), the control unit 11 proceeds to step S27.

If it is determined that the path to the folder is stored in the access permission table 12c (YES in S31), the control unit 11 notifies the user to become the external user of the storage of the data (step S32). In detail, the control unit 11 transmits a message representing that the login user stores the data to the e-mail address stored in the record having the path of the folder in the access permission table 12c through the communication unit 14. Next, the control unit 11 proceeds to step S27. Further, the control unit 11 executes the control program 12a in step S32, and thus serves as a storage processing notification unit of the present invention.

The server apparatus 1 performs the above processing, and thus the login user may create a folder and store data in the generated folder. Further, the server apparatus 1 may perform the processing in addition to the above-described generation of the folder and the storage of the data in response to the request of the login user. The processing is, for example, processing which may be performed by a known file sharing system, such as processing to enable the login user to read the data from the data table 12e and browse the data, processing to enable the login user to download the data to the client apparatus 2 or the like.

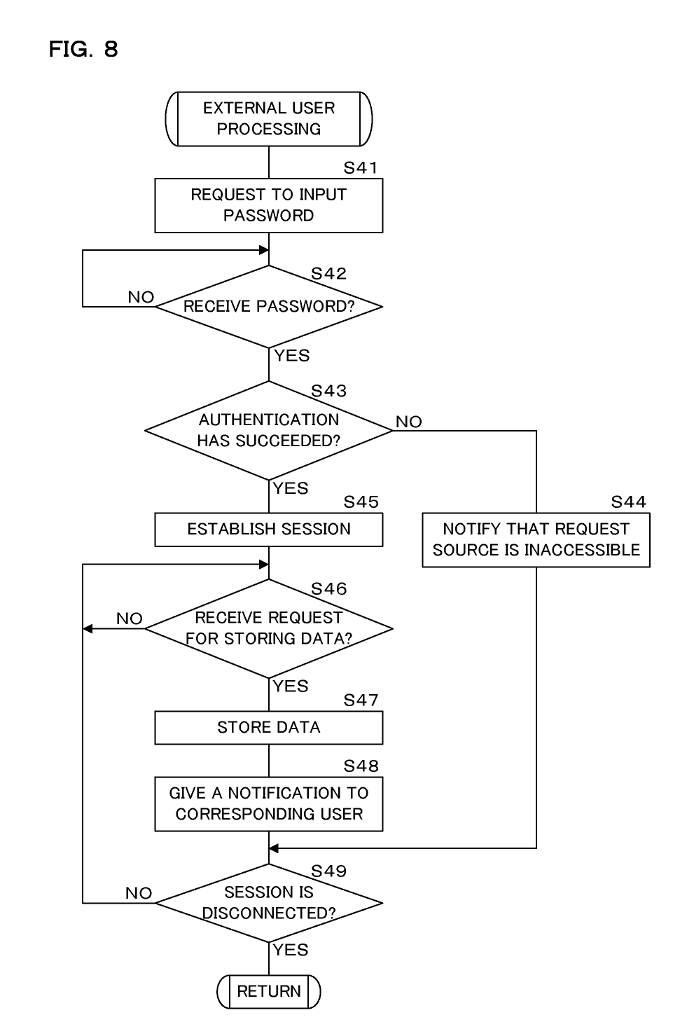

FIG. 8 is a flow chart illustrating a subroutine of the external user processing. The control unit 11 of the server apparatus 1 requests the external user to input a password (step S41). The control unit 11 transmits, for example, information for displaying a dialogue box for urging the input of the password to the client apparatus 2 which is used by the external user. The client apparatus 2 which is used by the external user represents the client apparatus 2 which transmits the access request if it is determined that the specific URL is requested in step S13 of FIG. 6.

Then, the control unit 11 determines whether the communication unit 14 receives the password (step S42). If it is determined that the communication unit 14 does not receive the password (NO in S42), the control unit 11 waits for the processing until the communication unit 14 receives the password. Further, the communication unit 14 corresponds to a password information receiving unit of the present invention.

If it is determined that the communication unit 14 receives the password (YES in S42), the control unit 11 determines whether the authentication of the received password has succeeded (step S43). In detail, the control unit 11 performs the determination based on whether the communication unit 14 receives the password corresponding to the URL information including the URL requested in the received access request, with reference to the access permission table 12c. If it is determined that the authentication has not succeed (NO in S43), the control unit 11 notifies the request source of the access request that the request source is inaccessible (step S44), and proceeds to step S49. Herein, the processing in step S44 is similar to step S15 of FIG. 6, and therefore will not be described. Further, the control unit 11 executes the control program 12a in step S43, and thus serves as a password information determination unit of the present invention.

If it is determined that the authentication has succeeded (YES in S43), the control unit 11 establishes a session with the above-described client apparatus 2 which is used by the external user (step S45). Further, the control unit 11 executes the control program 12a in step S45, and thus serves as an access permission unit of the present invention.

Next, the control unit 11 determines whether the communication unit 14 receives the request for storing data (step S46). Herein, the processing in step S46 is similar to step S29 of FIG. 7, and therefore will not be described. If it is determined that the communication unit 14 does not receive the request for storing data (NO in S46), the control unit 11 waits for the processing until the communication unit 14 receives the request for storing data.

If it is determined that the communication unit 14 receives the request for storing data (YES in S46), the control unit 11 stores data (step S47). Herein, the processing in step S47 is similar to step S30 of FIG. 7, and therefore will not be described.

Then, the control unit 11 gives a notification to the corresponding user (step S48). The control unit 11 transmits, for example, the message representing that the external user stores the data to the e-mail address corresponding to the login user creating the folder stored the data in step S47 through the communication unit 14, with reference to the registration information table 12b and the data table 12e. Further, the control unit 11 executes the control program 12a in step S48, and thus serves as the storage processing notification unit of the present invention.

Thereafter, the control unit 11 determines whether the session established in step S45 is disconnected (step S49). If it is determined that the session is not disconnected (NO in S49), the control unit 11 returns the processing to step S46. If it is determined that the session is disconnected (YES in S49), the control unit 11 returns from the subroutine of the external user processing to the processing of FIG. 6, and then ends the processing.

The server apparatus 1 performs the above-described processing, and even a user who is not the login user, that is, a user who is not registered in the registration information table 12b in advance may store the data in the folder to which the access is permitted. Further, the server apparatus 1 may perform the processing in addition to the above-described storage of the data in response to the request from the external user. Herein, the processing is, for example, processing to enable the external user to read the data stored in the folder to which the access is permitted from the data table 12e and to browse the data, processing to enable the external user to download the data to the client apparatus 2 or the like.

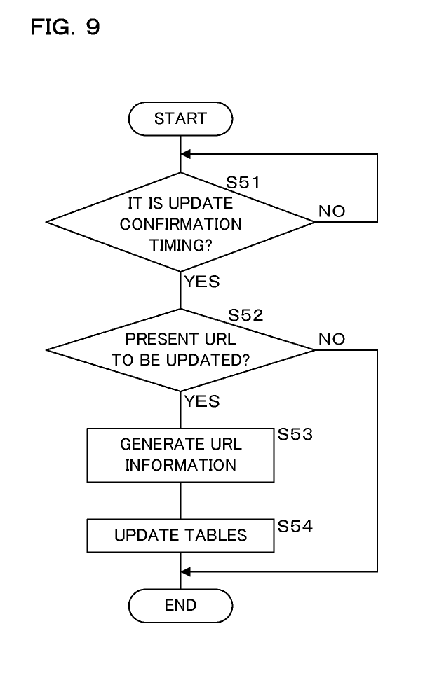

FIG. 9 is a flow chart illustrating the processing procedure of the server apparatus 1 if updating a URL for permitting access to a specific folder. The control unit 11 of the server apparatus 1 determines whether it is an update confirmation timing (step S51). The update confirmation timing is a timing for confirming whether the URL information stored in the access permission table 12c needs to be updated. For example, the control unit 11 determines whether it is the update confirmation timing based on whether the date and time output from the clock unit 16 are a predetermined time such as 3 a.m. If it is determined that it is not the update confirmation timing (NO in S51), the control unit 11 waits for the processing until the update confirmation timing arrives.

If it is determined that it is the update confirmation timing (YES in S51), the control unit 11 determines whether the URL to be updated is present (step S52). In detail, the control unit 11 makes determination based on whether a record that the period from the date of updating to the update confirmation timing has passed the corresponding update interval is present, with reference to the update management table 12d. Further, the control unit 11 executes the control program 12a in step S52, and thus serves as an update determination unit of the present invention.

If it is determined that the URL to be updated is not present (NO in S52), the control unit 11 ends the processing. If it is determined that the URL to be updated is present (YES in S52), the control unit 11 generates the URL information (step S53). In detail, the control unit 11 generates the URL information based on the e-mail address of the record having the path to be accessed which is similar to the path to be accessed of the record, determined in step S52, in the update management table 12d passing the update interval, with reference to the access permission table 12c. In this case, the control unit 11 generates the URL information which is different from the URL information stored in the record. Further, the control unit 11 executes the control program 12a in step S53, and thus serves as the generation unit of the present invention.

Next, the control unit 11 updates the tables (step S54). In detail, if the URL information is generated in step S53, the control unit 11 updates the URL information in the record of the access permission table 12c to the URL information generated in step S53. Further, the control unit 11 updates the date of updating of the record, determined in step S52, in the update management table 12d passing the update interval to a date determined as the update confirmation timing in step S51. Thereafter, the control unit 11 ends the processing.

By the above configuration and processing, the server apparatus 1 enables the login user as well as the external user performing the access request for requesting the specific URL to access the corresponding storage location, and may inhibit the access in other access requests. Therefore, it is possible to improve convenience and maintain security if sharing the file.

Further, the login user notifies the user to become the external user of the password required if accessing the folder, and thus even if the specific URL is leaked to a third party, the third party may not access the folder. Therefore, it is possible to more reliably maintain the security.

Further, if the login user creates the folder, the URL for accessing the folder may be notified to the user to become the external user, thereby further improving the convenience.

Further, the URL for accessing the folder is generated based on the e-mail address of the user to become the external user, and therefore the access to the folder by the server apparatus 1 may be easily managed.

Further, since the URL is periodically updated, even if the URL is leaked to a third party, the leaked URL is updated and thus it is possible to prevent the third party from accessing the corresponding folder.

### Embodiment 2

Embodiment 1 describes that the server apparatus 1 requests the login information of the request source of the access request and the authentication is performed based on the login information, while Embodiment 2 describes an example in which the authentication is performed using other device. Further, Embodiment 1 describes that the server apparatus 1 generates the folder in its own storage unit 12 and the data are stored in the created folder, while Embodiment 2 describes an example in which the folder is generated in the other devices and the data are stored in the folder. Further, other configurations and functions other than those to be described below are similar to the above-described Embodiment 1, and therefore the similar configuration and the function and effect thereof will not also be described for simplification.

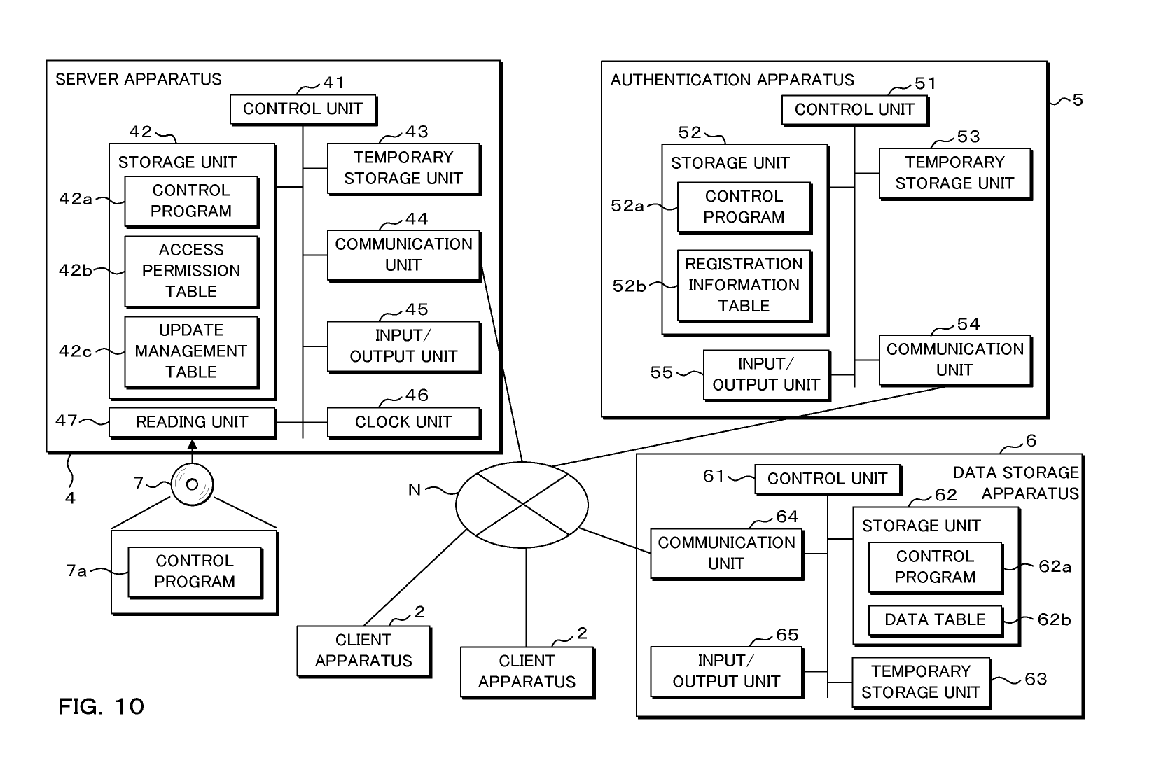

FIG. 10 is a block diagram illustrating a configuration of each apparatus of a file sharing system according to Embodiment 2. In Embodiment 2, a server apparatus 4, an authentication apparatus 5, a data storage apparatus 6, and a plurality of client apparatuses 2 are connected to the network N. The server apparatus 4 has a configuration similar to the server apparatus 1 in Embodiment 1, and therefore only different components will be described below.

In a storage unit 42 of the server apparatus 4, a control program 42a is stored. The control program 42a is a program in which processing contents performed by communication with the client apparatus 2, the authentication apparatus 5, and the data storage apparatus 6, and processing contents by the control unit 41 controlling each unit included in the server apparatus 4 are described.

Further, in the storage unit 42, an access permission table 42b and an update management table 42c are stored. The access permission table 42b is similar to the access permission table 12c in Embodiment 1, and the update management table 42c is the same as the update management table 12d in Embodiment 1, and therefore will not be described.

Further, a reading unit 47 reads data which are recorded in a recording medium 7 such as a USB device, a CD-ROM, a DVD, a Blu-ray disk, and a flexible disk, and stores the read data in a temporary storage unit 43 or the storage unit 42. In the recording medium 7, a control program 7a which is executed by the control unit 41 to operate the server apparatus 4 is recorded. The control program 42a which is stored in the storage unit 42 may be a copy of a control program 7a which is read from the recording medium 7 by the reading unit 47.

The authentication apparatus 5 includes a control unit 51 which controls an operation of each component of the authentication apparatus 5. The control unit 51 includes, for example, one or a plurality of CPUs, a multi-core CPU and the like. Further, the authentication apparatus 5 includes a storage unit 52, a temporary storage unit 53, a communication unit 54, and an input/output unit 55, which are connected to the control unit 51 through a bus. The control unit 51 controls each unit by reading a control program 52a which is stored in the storage unit 52 to be described below.

The storage unit 52 is configured with a nonvolatile memory such as the EEPROM, the flash memory, the HDD or the like. In the storage unit 52, the control program 52a is stored. The control program 52a is a program in which processing contents performed by communication with the client apparatus 2 and the server apparatus 4, and processing contents by the control unit 51 controlling each unit included in the authentication apparatus 5 are described.

Further, in the storage unit 52, a registration information table 52b is stored. The registration information table 52b is similar to the registration information table 12b in Embodiment 1, and therefore will not be described.

The temporary storage unit 53 is configured with a memory such as the SRAM, the DRAM or the like. The temporary storage unit 53 temporarily stores various kinds of data which are generated by allowing the control unit 51 to perform the processing by the control program 52a.

The communication unit 54 is configured to be connected to the network N, and transmits and receives information to and from the client apparatus 2 and the server apparatus 4 by the communication protocols such as the HTTP, the FTP, or the like, based on the commands from the control unit 51. Further, the communication unit 54 may perform the communication with the server apparatus 4 under the encrypted condition using the protocols such as the SSH, the SSL/TLS or the like.

The input/output unit 55 is connected to the input/output apparatus such as a keyboard, a display, etc. from the outside, outputs an input signal from the input/output apparatus to the control unit 51, and outputs an output signal from the control unit 51 to the input/output apparatus.

The data storage apparatus 6 includes a control unit 61 which controls an operation of each component of the data storage apparatus 6. The control unit 61 includes, for example, one or a plurality of CPUs, a multi-core CPU or the like. Further, the data storage apparatus 6 includes a storage unit 62, a temporary storage unit 63, a communication unit 64, and an input/output unit 65, which are connected to the control unit 61 through a bus. The control unit 61 controls each unit by reading a control program 62a which is stored in the storage unit 62 to be described below.

The storage unit 62 is configured with a nonvolatile memory such as the EEPROM, the flash memory, the HDD or the like. In the storage unit 62, the control program 62a is stored. The control program 62a is a program in which processing contents performed by communication with the server apparatus 4, and processing contents by the control unit 61 controlling each unit included in the data storage apparatus 6 are described.

Further, in the storage unit 62, a data table 62b is stored. The data table 62b is similar to the data table 12e in Embodiment 1, and therefore will not be described.

The temporary storage unit 63 is configured with a memory such as the SRAM, the DRAM or the like. The temporary storage unit 63 temporarily stores various kinds of data which are generated by allowing the control unit 61 to perform the processing by the control program 62a.

The communication unit 64 is configured to be connected to the network N, and transmits and receives information to and from the server apparatus 4 by the communication protocols such as the HTTP, the FTP, or the like, based on the commands from the control unit 61. Further, the communication unit 64 may perform the communication with the server apparatus 4 under the encrypted condition using the protocols such as the SSH, the SSL/TLS or the like.

The input/output unit 65 is connected to the an input/output apparatus such as a keyboard, a display, etc. from the outside, outputs an input signal from the input/output apparatus to the control unit 61, and outputs an output signal from the control unit 61 to the input/output apparatus.

From the above description, the server apparatus 4, the authentication apparatus 5, and the data storage apparatus 6 may be configured to dispersedly store the tables stored in the storage unit 12 of the server apparatus 1 in Embodiment 1. Further, the server apparatus 4, the authentication apparatus 5, and the data storage apparatus 6 correspond to the information processing system of the present invention.

In the file sharing system according to Embodiment 2, the client apparatus 2 receives an operation from the user, and outputs a request such as the access request to the server apparatus 4. When receiving the request from the client apparatus 2, the server apparatus 4 communicates with the authentication apparatus 5 or the data storage apparatus 6 to execute various kinds of processing. Hereinafter, the processing when the server apparatus 4 receives the access request transmitted from the client apparatus 2, and the processing of the authentication apparatus 5 will be described with reference to a flow chart.

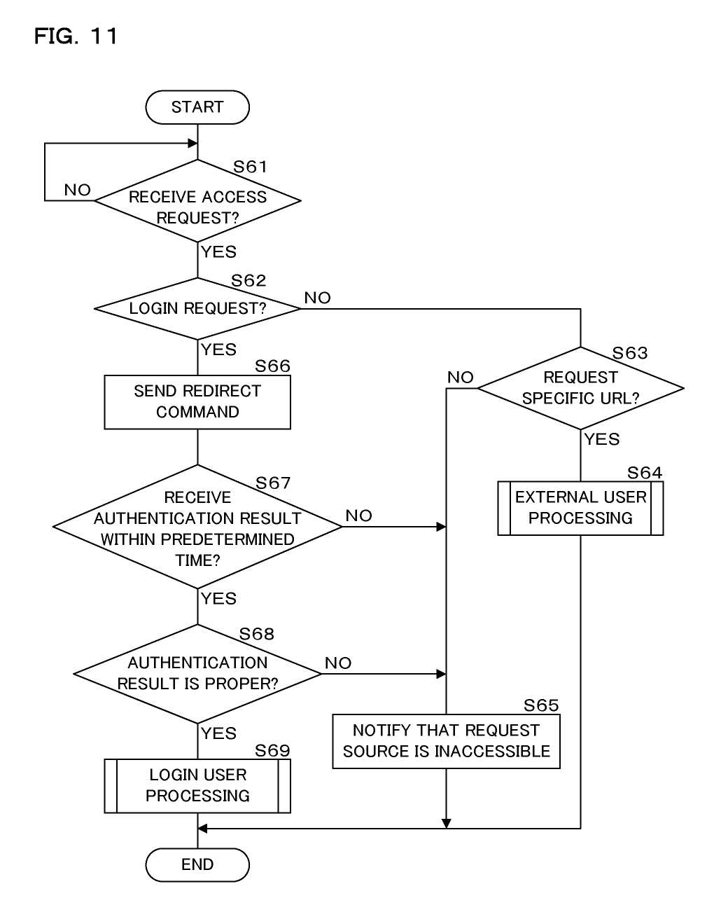

FIG. 11 is a flow chart illustrating a processing procedure of the server apparatus 4 if receiving the access request. Further, steps S61 to S63 and step S65 are similar to steps S11 to S13 and step S15 of FIG. 6 in Embodiment 1, respectively, and therefore will not be described. Further, the processing of steps S64 and S69 are similar to those of steps S14 and S19 of FIG. 6, respectively, and therefore only the different portions therefrom will be described.

If it is determined that the access request is the login request in step S62 (YES in S62), the control unit 41 of the server apparatus 4 transmits a redirect command representing a redirect to the authentication apparatus 5 to the client apparatus 2 of a transmission source of the access request determined as being received in step S61 (step S66). Herein, the client apparatus 2 transmits the access request to the authentication apparatus 5 based on the redirect command from the server apparatus 4, and the authentication apparatus 5 authenticates whether the user of the client apparatus 2 is the login user based on the access request from the client apparatus 2 to transmit an authentication result to the server apparatus 4 if the user is authenticated. Further, the processing of the authentication apparatus 5 will be described below.

Then, the control unit 41 determines whether the communication unit 44 receives the authentication result from the authentication apparatus 5 within a predetermined time (step S67). The predetermined time is, for example, 3 minutes starting with a time when the redirect command is transmitted in step S66. If it is determined that the communication unit 44 does not receive the authentication result (NO in S67), the control unit 41 proceeds to step S65.

If it is determined that the communication unit 44 receives the authentication result (YES in S67), the control unit 41 determines whether the received authentication result is proper (step S68). The control unit 41 performs the determination based on whether the received authentication result is transmitted from the authentication apparatus 5. If it is determined that the authentication result is not proper (NO in S68), the control unit 41 proceeds to step S65, and then ends the processing. If it is determined that the authentication result is proper (YES in S68), the control unit 41 proceeds to step S69, and then ends the processing. Further, the control unit 41 executes the control program 42a in step S68, and thus serves as the authenticated person determination unit of the present invention.

Next, with reference to steps S64 and S69, different portions from Embodiment 1 will be described. In steps S23 and S30 of FIG. 7 in Embodiment 1 and step S47 of FIG. 8, the control unit 11 creates the folder in the storage unit 12 and stores the data therein. In Embodiment 2, the control unit 41 communicates with the data storage apparatus 6 in each step as described above, and creates the folder in the storage unit 62 of the data storage apparatus 6 and stores the data therein. That is, in Embodiment 2, the server apparatus 4 secures a storage location of the data in the data storage apparatus 6, and performs the storage processing of the data in the secured storage location.

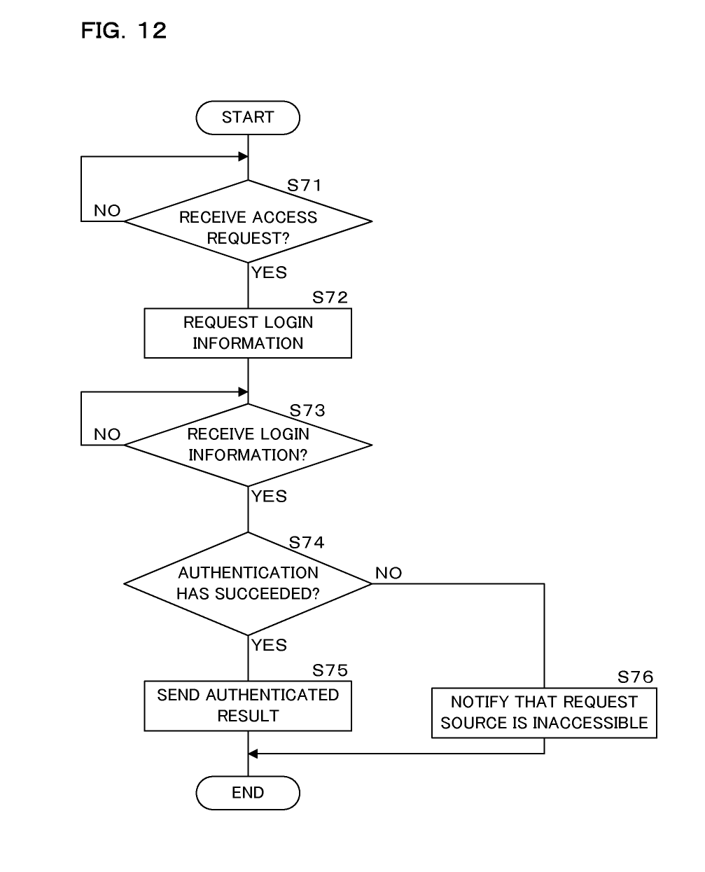

Next, the processing to be performed by the authentication apparatus 5 will be described. FIG. 12 is a flow chart illustrating a processing procedure of the authentication apparatus 5 if receiving the access request. Further, the processing of steps S72 to S74 which are executed by the control unit 51 of the authentication apparatus 5 is similar to that of steps S16 to S18 of FIG. 6 which are executed by the control unit 11 of the server apparatus 1, and therefore will not be described. Further, the processing of step S76 which is executed by the control unit 51 is similar to that of step S15 of FIG. 6 which is executed by the control unit 11 in Embodiment 1, and therefore will not be described.

The control unit 51 of the authentication apparatus 5 determines whether the communication unit 54 receives an access request from the client apparatus 2 (step S71). The access request is based on the redirect command which is transmitted from the server apparatus 4 in step S66 of FIG. 11. If it is determined that the communication unit 54 does not receive the access request (NO in S71), the control unit 51 waits for the processing until the communication unit 54 receives the access request. If it is determined that the communication unit 54 receives the access request (YES in S71), the control unit 51 proceeds to step S72.

Thereafter, if it is determined that the authentication has succeeded in step S74 (YES in S74), the control unit 51 transmits the authentication result representing that the authentication has succeeded to the server apparatus 4 (step S75), and ends the processing. Meanwhile, if it is determined that the authentication has not succeeded (NO in S74), the control unit 51 proceeds to step S76, and then ends the processing.

By the above configuration and processing, an effect similar to that in Embodiment 1 may be obtained. Further, in Embodiment 2, the data table 62b is stored in the data storage apparatus 6. Therefore, it is possible to use resources of the data storage apparatus 6, and for example, store data having capacity beyond a storage region of the server apparatus 4. Further, the registration information table 52b is stored in the authentication apparatus 5. Therefore, for example, the authentication apparatus 5 may be connected to a private network which is used by the login user, to share a file without transmitting secret information such as a login password to the public communication network such as the Internet. Further, each table stored in the storage unit 12 of the server apparatus 1 in Embodiment 1 is dispersedly stored in each apparatus, and therefore a configuration more robust for the leakage of information may be possible, as compared with the case of storing all information in a single apparatus. Further, Embodiment 2 describes that one authentication apparatus 5 and one data storage apparatus 6 are included, but a plurality of the authentication apparatuses 5 and the data storage apparatuses 6 may be included. In this case, for example, the authentication apparatus 5 may be prepared as many as the number of login users, and the number of the data storage apparatuses 6 to be prepared may appropriately be increased in response to the stored data amount.

### Embodiment 3

In Embodiment 3, one or a plurality of image forming apparatuses such as a printer are connected to the network N. The server apparatus 1 or 4 is configured to be able to communicate with the image forming apparatus, and instructs the image forming apparatus to perform printing processing of data, in response to the request from the login user or the external user.

By the above configuration and processing, even if data required for printing processing are not stored in the client apparatus 2 in use, the login user or the external user may print the data using the image forming apparatus. Further, configurations and functions other than those to be described below are similar to the above-described Embodiments 1 and 2, and therefore similar configuration and the function and effect thereof will not also be described for simplification.

An information processing apparatus (1, 4) according to the present invention may comprise: a receiving unit (14, 44) configured to receive an access request through a communication network; an authenticated person determination unit (11, 41) configured to determine whether a request source of the access request received by the receiving unit (14, 44) is an authenticated person representing an authenticated request source; a storage location securing unit (11, 41) configured, if the authenticated person determination unit (11, 41) determines that the request source is the authenticated person, to secure a storage location of data in response to a request of the authenticated person; an execution unit (11, 41) configured to execute storage processing of data in the storage location secured by the storage location securing unit (11, 41); a storage unit (12, 42) configured, after the storage location securing unit (11, 41) secures the storage location of data, to store location information representing the storage location and an access request to be permitted access to the storage location in association with each other; a storage determination unit (11, 41) configured, if the receiving unit (14, 44) receives an access request, to determine whether the access request is stored in the storage unit (12, 42); and an access permission unit (11, 41) configured to permit access to the storage location represented by the location information corresponding to the access request if the storage determination unit (11, 41) determines that the access request is stored in the storage unit (12, 42).

According to the present invention, if receiving the specific access request stored in the storage unit (12, 42), the information processing apparatus (1, 4) permits access to the storage location secured by the authenticated person. Therefore, the information processing apparatus (1, 4) makes the specific access request to permit a person other than the authenticated person to access the corresponding storage location, and inhibit such person to access the storage location for other access requests. Therefore, it is possible to improve convenience and maintain security if sharing the file.

In the information processing apparatus (1, 4) according to the present invention, the storage unit (12, 42) is configured to store password information in association with the access request, the information processing apparatus (1, 4) further comprises: a password information receiving unit (14, 44) configured, if the storage determination unit (11, 41) determines that an access request is stored in the storage unit (12, 42), to receive password information; and a password information determination unit (11, 41) configured to determine whether password information received by the password information receiving unit (14, 44) agrees with the password information stored in the storage unit (12, 42) in association with the access request, and wherein, the access permission unit (11, 41) is configured to permit access to the storage location represented by the location information corresponding to the access request if the password information determination unit (11, 41) determines that the received password information agrees with the stored password information.

According to the present invention, if receiving the specific access request stored in the storage unit (12, 42), the information processing apparatus (1, 4) receive the password information from the password information receiving unit (14, 44). When the received password information corresponds to the access request, the information processing apparatus (1, 4) permits access to the storage location. Even if a person who should not be permitted the access to the storage location requests the specific access, a password is not notified to the person to prevent the access from being permitted to the person, thereby more reliably maintaining the security.

In the information processing apparatus (1, 4) according to the present invention, the access request includes a URL requesting access, the storage unit (12, 42) is configured to store contact information representing a contact address of a permitted person to be permitted access to the storage location, in association with the location information representing the storage location and the access request corresponding to the location information, and the information processing apparatus (1, 4) further comprises: a URL notification unit (11, 41) configured to notify, of the URL included in the access request corresponding to the contact information stored in the storage unit (12, 42), the contact address represented by the contact information.

According to the present invention, if the storage location is secured by the authenticated person, for example, the information processing apparatus (1, 4) may notify the permitted person of the URL included in the specific access request. Therefore, the permitted person may perform the specific access request using the notified URL, thereby further improving the convenience.

The information processing apparatus (1, 4) according to the present invention may further comprising a generation unit (11, 41) configured, based on the contact information, to generate the URL included in the access request corresponding to the contact information.

According to the present invention, the information processing apparatus (1, 4) may individually generate the URL included in the access request to the storage location, based on the contact information of each permitted person to be permitted access to the storage location. Therefore, the permitted person which accesses the storage location may be identified, based on the URL included in the received access request, thereby more easily managing the access.

In the information processing apparatus (1, 4) according to the present invention, the storage unit (12, 42) is configured to store a time point when the generation unit (11, 41) generates the URL and an update timing of the URL, in association with the access request including the URL, the information processing apparatus (1, 4) further comprises: an update determination unit (11, 41) configured to determine, based on the time point when the URL is generated and the update timing of the URL, whether an update of the URL is required, and wherein, if the update determination unit (11, 41) determines that the update of the URL is required, the generation unit (11, 41) is configured to generate a URL different from the URL required to be updated.

According to the present invention, the information processing apparatus (1, 4) periodically performs the update of the URL based on the update timing. Therefore, even if the URL is leaked to the person who should not be permitted the access to the storage location, the URL is updated, so that the person may not access to the storage location in the access request including the leaked URL.

The information processing apparatus (1, 4) according to the present invention may further comprising a storage processing notification unit (11, 41) configured, if storage processing is executed for the storage location represented by the location information stored in the storage unit (12, 42), based on the request of the request source which is determined to be the authenticated person, to give a notification to the contact address represented by the contact information corresponding to the location information.

According to the present invention, if the authenticated person stores the data in the storage location, the information processing apparatus (1, 4) may notify the permitted person of the access to the storage location, thereby further improving the convenience.

In the information processing apparatus (1, 4) according to the present invention, the execution unit (11, 41) is configured, in response to a request of the request source of the access request for which access to the storage location is permitted by the access permission unit (11, 41), to execute storage processing for the storage location, the storage unit (12, 42) is configured to store authenticated person contact information representing the contact address of the authenticated person securing the storage location, in association with the location information representing the storage location, and if the execution unit (11, 41) executes the storage processing for the storage location in response to the request of the request source, the storage processing notification unit (11, 41) is configured to give a notification to the contact address represented by the authenticated person contact information corresponding to the location information representing the storage location.

According to the present invention, if the request source performing the specific access request stores the data in the storage location, the information processing apparatus (1, 4) may give a notification to the authenticated person securing the storage location, thereby further improving the convenience.

An information processing system according to the present invention may comprise: the information processing apparatus (1, 4) described above; a data storage apparatus (6) having a storage location of data on which the information processing apparatus (1, 4) executes storage processing; and an authentication apparatus (5) configured to authenticate whether a request source of an access request received by the information processing apparatus (1, 4) is an authenticated person to be allowed to secure the storage location of data in the information processing apparatus (1, 4), and output an authentication result to the information processing apparatus (1, 4), wherein the information processing apparatus (1, 4) is configured to determine whether the request source is the authenticated person based on an authentication result output from the authentication apparatus (5).

According to the present invention, the information processing apparatus (1, 4) may secure the storage location of the data in the data storage apparatus (6), and store the data in the secured storage location. Therefore, it is possible to use resources other than the information processing apparatus (1, 4), and for example, store data having capacity beyond the storage region of the information processing apparatus (1, 4). Further, the information processing apparatus (1, 4) may determine whether the request source is the authenticated person, based on the authentication result output from the authentication apparatus (5). Therefore, it is possible for the information processing apparatus (1, 4) not to store the information required for authentication, and to determine whether the request source is the authenticated person without transmitting the secret information such as the password required for authentication to the communication network.

An information processing method according to the present invention may comprise the steps of: receiving an access request through a communication network; determining whether a request source of the received access request is an authenticated person representing an authenticated request source; if it is determined that the request source is the authenticated person, securing a storage location of data in response to a request of the authenticated person; executing storage processing of data in the secured storage location; after the storage location of data is secured, storing location information representing the storage location and an access request to be permitted access to the storage location in association with each other; if an access request is received, determining whether the access request is stored, and permitting access to the storage location represented by the location information corresponding to the access request if the access request is determined as being stored.

According to the present invention, if receiving the stored specific access request, the access to the storage location secured by the authenticated person is permitted. Therefore, a person other than the authenticated person may make the specific access request, and thus may access the corresponding storage location, while the access to the storage location is inhibited for other access requests. Therefore, it is possible to improve convenience and maintain security if sharing the file.

A computer program (3a, 7a) according to the present invention, which causes a computer connected to a communication network to receive an access request through a communication network to execute the steps of: determining whether a request source of the received access request is an authenticated person representing an authenticated request source; if it is determined that the request source is the authenticated person, securing a storage location of data in response to a request of the authenticated person; executing storage processing of data in the secured storage location; after the storage location of data is secured, storing location information representing the storage location and an access request to be permitted access to the storage location in association with each other; if an access request is received, determining whether the access request is stored, and permitting access to the storage location represented by the location information corresponding to the access request if the access request is determined as being stored.

According to the present invention, if receiving the stored specific access request, the access to the storage location secured by the authenticated person may be permitted. Therefore, a person other than the authenticated person may make the specific access request to access the corresponding storage location, while the access to the storage location is inhibited for other access requests. Therefore, it is possible to improve convenience and maintain security if sharing the file.

What is claimed is:

1. An information processing apparatus, comprising:
a receiving unit configured to receive an access request through a communication network;
an authenticated person determination unit configured to determine whether a request source of the access request received by the receiving unit is an authenticated person representing an authenticated request source;
a storage location securing unit configured, if the authenticated person determination unit determines that the request source is the authenticated person, to secure a storage location of data in response to a request of the authenticated person;
an execution unit configured to execute storage processing of data in the storage location secured by the storage location securing unit;
a storage unit configured, after the storage location securing unit secures the storage location of data, to store location information representing the storage location and an access request to be permitted access to the storage location in association with each other;
a storage determination unit configured, if the receiving unit receives an access request, to determine whether the access request is stored in the storage unit; and
an access permission unit configured to permit access to the storage location represented by the location information corresponding to the access request if the storage determination unit determines that the access request is stored in the storage unit.

2. The information processing apparatus according to claim 1, wherein the storage unit is configured to store password information in association with the access request,
the information processing apparatus further comprises:
a password information receiving unit configured, if the storage determination unit determines that an access request is stored in the storage unit, to receive password information; and
a password information determination unit configured to determine whether password information received by the password information receiving unit agrees with the password information stored in the storage unit in association with the access request, and
wherein, the access permission unit is configured to permit access to the storage location represented by the location information corresponding to the access request if the password information determination unit determines that the received password information agrees with the stored password information.

3. The information processing apparatus according to claim 1, wherein the access request includes a URL requesting access,
the storage unit is configured to store contact information representing a contact address of a permitted person to be permitted access to the storage location, in association with the location information representing the storage location and the access request corresponding to the location information, and
the information processing apparatus further comprises:
a URL notification unit configured to notify, of the URL included in the access request corresponding to the contact information stored in the storage unit, the contact address represented by the contact information.

4. The information processing apparatus according to claim 3, further comprising
a generation unit configured, based on the contact information, to generate the URL included in the access request corresponding to the contact information.

5. The information processing apparatus according to claim 4, wherein the storage unit is configured to store a time point when the generation unit generates the URL and an update timing of the URL, in association with the access request including the URL,
the information processing apparatus further comprises:
an update determination unit configured to determine, based on the time point when the URL is generated and the update timing of the URL, whether an update of the URL is required, and
wherein, if the update determination unit determines that the update of the URL is required, the generation unit is configured to generate a URL different from the URL required to be updated.

6. The information processing apparatus according to claim 3, further comprising
a storage processing notification unit configured, if storage processing is executed for the storage location represented by the location information stored in the storage unit, based on the request of the request source which is determined to be the authenticated person, to give a notification to the contact address represented by the contact information corresponding to the location information.

7. The information processing apparatus according to claim 6, wherein
the execution unit is configured, in response to a request of the request source of the access request for which access to the storage location is permitted by the access permission unit, to execute storage processing for the storage location,
the storage unit is configured to store authenticated person contact information representing the contact address of the authenticated person securing the storage location, in association with the location information representing the storage location, and
if the execution unit executes the storage processing for the storage location in response to the request of the request source, the storage processing notification unit is configured to give a notification to the contact address represented by the authenticated person contact information corresponding to the location information representing the storage location.

8. An information processing system, comprising:
the information processing apparatus according to claim 1;
a data storage apparatus having a storage location of data on which the information processing apparatus executes storage processing; and
an authentication apparatus configured to authenticate whether a request source of an access request received by the information processing apparatus is an authenticated person to be allowed to secure the storage location of data in the information processing apparatus, and output an authentication result to the information processing apparatus,
wherein the information processing apparatus is configured to determine whether the request source is the authenticated person based on an authentication result output from the authentication apparatus.

9. An information processing method, comprising the steps of:
receiving an access request through a communication network;
determining whether a request source of the received access request is an authenticated person representing an authenticated request source;
if it is determined that the request source is the authenticated person, securing a storage location of data in response to a request of the authenticated person;
executing storage processing of data in the secured storage location;
after the storage location of data is secured, storing location information representing the storage location and an access request to be permitted access to the storage location in association with each other;
if an access request is received, determining whether the access request is stored, and
permitting access to the storage location represented by the location information corresponding to the access request if the access request is determined as being stored.

10. A non-transitory recording medium, in which a computer program is stored, in a computer connected to a communication network to receive an access request through the communication network, the computer program comprising the steps of:
determining whether a request source of the received access request is an authenticated person representing an authenticated request source;
if it is determined that the request source is the authenticated person, securing a storage location of data in response to a request of the authenticated person;
executing storage processing of data in the secured storage location;
after the storage location of data is secured, storing location information representing the storage location and an access request to be permitted access to the storage location in association with each other;
if an access request is received, determining whether the access request is stored, and
permitting access to the storage location represented by the location information corresponding to the access request if the access request is determined as being stored.
